(19) United States
(12) Patent Application Publication
(10) Pub. No.: US 2025/0078825 A1
(43) Pub. Date: Mar. 6, 2025

(54) FRONT-END AUDIO PROCESSING FOR AUTOMATIC SPEECH RECOGNITION

(71) Applicant: SHURE ACQUISITION HOLDINGS, INC., Niles, IL (US)

(72) Inventors: Wenshun Tian, Palatine, IL (US); Michael Lester, Buena Vista, CO (US); Brent Shumard, Mount Prospect, IL (US); Bibo Gao, Buffalo Grove, IL (US)

(21) Appl. No.: 18/817,608

(22) Filed: Aug. 28, 2024

Related U.S. Application Data
(60) Provisional application No. 63/579,211, filed on Aug. 28, 2023.

(51) Int. Cl. G10L 15/183; G06V 20/40; G10L 15/02; G10L 21/028; G10L 25/57; H04R 3/00

(52) U.S. Cl. CPC G10L 15/183; G06V 20/46; G10L 15/02; G10L 21/028; G10L 25/57; H04R 3/005

(57) ABSTRACT

Techniques are disclosed herein for providing front-end audio processing for automatic speech recognition. Examples may include receiving audio data from one or more microphone array devices located within an audio environment, extracting an audio feature set from the audio data, inputting the audio feature set to an audio source separation model to generate an audio speech signal configured for automatic speech recognition (ASR), inputting the audio speech signal to an ASR model configured to generate textual data, and outputting the textual data to a post-processing system.

### CROSS REFERENCE TO RELATED APPLICATIONS

This application claims the benefit of U.S. Provisional Patent Application No. 63/579,211, titled “FRONT-END AUDIO PROCESSING FOR AUTOMATIC SPEECH RECOGNITION,” and filed on Aug. 28, 2023, the entirety of which is hereby incorporated by reference.

### TECHNICAL FIELD

Embodiments of the present disclosure relate generally to audio processing and, more particularly, to systems configured to provide audio pre-processing for automatic speech recognition.

### BACKGROUND

An audio system may utilize an array of microphones in an audio environment to capture audio data. However, existing techniques for capturing, processing, and/or transmitting audio data captured by an array of microphones in audio environments with multiple audio sources are prone to inaccuracies and/or inefficiencies.

### BRIEF SUMMARY

Various embodiments of the present disclosure are directed to apparatuses, systems, methods, and computer readable media for front-end audio processing for automatic speech recognition. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio signal processing system configured to execute automatic speech recognition (ASR) pre-processing operations in accordance with one or more embodiments disclosed herein;

FIG. 2 illustrates an example ASR pre-processing apparatus configured in accordance with one or more embodiments disclosed herein;

FIG. 3 illustrates an example text post-processing system in accordance with one or more embodiments disclosed herein;

FIG. 4 illustrates an example audio environment in accordance with one or more embodiments disclosed herein;

FIG. 5 illustrates an example source separation sub-system in accordance with one or more embodiments disclosed herein; and

FIG. 6 illustrates an example method for providing front-end audio processing for automatic speech recognition in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio system for capturing audio within an audio environment may include a microphone array, a beamforming module, and/or other digital signal processing (DSP) elements. A beamforming module may be configured to combine microphone signals captured by a microphone array using one or more DSP processing techniques. Beamforming lobes of a microphone array may be directed to capture audio at fixed locations within an audio environment. However, for an audio environment with multiple sources of audio captured by a microphone array, traditional audio processing related to the microphone array may result in inaccuracies and/or inefficiencies for certain types of audio applications such as, for example, automatic speech recognition (ASR). For example, with typical audio systems, it is difficult to provide sufficient isolation to perform ASR in busy, noisy environments where more than one person or audio source is concurrently speaking and/or creating noise in a physical environment. Additionally, for scenarios in which a speaker is located in a highly reverberated room or surrounded by multiple interference acoustic sources, ASR provided by a typical audio system results in inaccuracies and/or inefficiencies due to the noise and artifacts introduced via audio captured by the microphone array. Moreover, merely relying on spatial correlations (e.g., merely utilizing beamforming for enhancing audio) does not provide sufficient isolation to perform ASR.

Various examples disclosed herein provide front-end audio processing for audio applications such as, for example, ASR related to microphone array systems. The front-end audio processing may be optimized for a particular audio application (e.g., ASR) in audio environments. In various examples, the front-end audio processing may be utilized for an audio environment (e.g., a noisy audio environment) where more than one person is concurrently speaking and/or creating noise.

### Example Audio Processing Systems and Methods

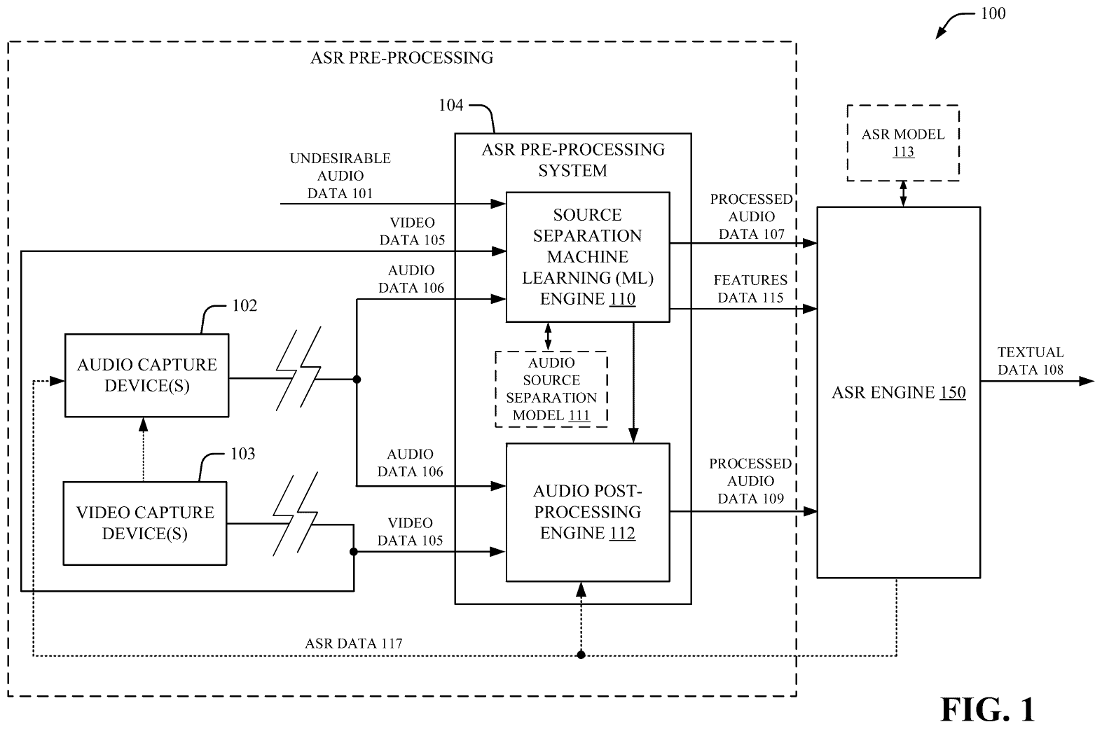

FIG. 1 illustrates an audio signal processing system 100 that is configured to provide ASR pre-processing in conjunction with a microphone array based on machine learning and/or post-processing transformation of audio data captured using the microphone array, according to embodiments of the present disclosure. For example, the audio signal processing system 100 provides front-end audio processing for automatic speech recognition. The audio signal processing system 100 may be, for example, a user experience system, an entertainment system, an audio environment system, an entertainment resort system, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, an augmented reality system, a virtual reality system, a gaming system, an online gaming system, or another type of audio system. Additionally, the audio signal processing system 100 may be implemented as an audio signal processing apparatus and/or as software that is configured for execution on a smartphone, a laptop, a personal computer, an entertainment device, a user experience device, a digital conference system, a wireless conference unit, an audio workstation device, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other DSP processing.

The audio signal processing system 100 may utilize the ASR pre-processing to provide various improvements related to audio processing such as, for example, to: automatically track and/or isolate a sound source in an audio environment, improve source separation for audio captured by a microphone array, optimize a steering lobe based on a tracked location of a sound source, optimize a coordinate change related to beamforming, optimize self-steering based on a tracked location of a sound source, improve localization accuracy associated with beamforming, improve efficiency of deploying a microphone array in an audio environment, reduce noise in an audio environment, improve ASR related to audio captured by a microphone array, improve text processing related to audio captured by a microphone array, improve large language modeling related to audio captured by a microphone array, and/or improve one or more other audio applications related to a microphone array.

The audio signal processing system 100 may also be adapted to produce improved audio signals with reduced noise, reduced reverberation, improved source separation, and/or a reduction in other undesirable audio artifacts. Additionally, the audio signal processing system 100 may provide improved audio quality for audio signals in an audio environment. An audio environment may be an indoor environment, an outdoor environment, an entertainment environment, a user experience environment, a room, a performance hall, a broadcasting environment, a sports stadium or arena, a virtual environment, or another type of audio environment. In various examples, the audio signal processing system 100 may be configured to remove or suppress noise, reverberation, and/or other undesirable sound from audio signals via digital signal processing. The audio signal processing system 100 may alternatively be employed for another type of sound enhancement application such as, but not limited to, active noise cancelation, adaptive noise cancelation, etc.

In various examples, the audio signal processing system 100 may utilize source separation associated with machine learning in combination with utilization of properties of spatial correlations in an audio environment to extract targeted speech from an audio signal mixture including desired speech, undesirable interference speech, undesirable reverberations, and/or noise. In some examples, the audio signal processing system 100 may additionally utilize video features related to video data captured in the audio environment to further improve estimated position of audio source and/or to further improve isolation of the desired speech. The video features may include: facial features, mouth features, eye features, object recognition features, facial recognition features, and/or one or more other features related to a speaker associated with the desired speech.

In various examples, the front-end audio processing provided by the audio signal processing system 100 may utilize a microphone array with front-end audio enhancements to further improve performance of the particular audio application (e.g., ASR). As such, the audio signal processing system 100 may provide improved filtering of noise in an audio environment, improved separation of desirable talkers from undesirable talkers in an audio environment, and/or reduced artifacts in audio provided to audio applications such as ASR.

The audio signal processing system 100 includes one or more audio capture devices 102. The one or more audio capture devices 102 may respectively be devices configured to capture audio from one or more sound sources. The one or more audio capture devices 102 may include one or more sensors configured for capturing audio by converting sound into one or more electrical signals. The audio captured by the one or more audio capture devices 102 may also be converted into audio data 106. The audio data 106 may be a digital audio data or, alternatively, analog audio data, related to the one or more electrical signals. In some examples, the audio data 106 may be beamformed audio data.

In an example, the one or more audio capture devices 102 are one or more microphones arrays. For example, the one or more audio capture devices 102 may correspond to one or more array microphones, one or more beamformed lobes of an array microphone, one or more linear array microphones, one or more ceiling array microphones, one or more table array microphones, or another type of array microphone. In some examples, the one or more audio capture devices 102 may include and/or be associated with one or more beamformers such as: a static beamformer with predefined steering locations, a static beamformer that is informed by a steering module that provides steering locations, a dynamic beamformer that may be adapted based on information related to a target voice and undesirable audio in an audio environment, a dynamic beamformer that utilizes covariance calculations between a target voice and undesirable audio in an audio environment, and/or another type of beamformer.

In some examples, the one or more audio capture devices 102 may utilize a standard delay and sum algorithm, a super-directional beamforming technique, and/or a minimum variance distortionless response (MVDR) technique for beamforming. In some examples, MVDR associated with the one or more audio capture devices 102 may utilize null values related undesirable audio to shape a beam pattern for the one or more audio capture devices 102. In some examples, a beamformer of the one or more audio capture devices 102 may include a certain number of steering locations (e.g., eight steering locations, etc.) crossing azimuth spans configured with a location uniform gain and/or zero gain values.

In alternate examples, the one or more audio capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more audio capture devices 102 may additionally or alternatively include one or more infrared capture devices, one or more sensor devices, one or more video capture devices (e.g., one or more video capture devices 103), and/or one or more other types of audio capture devices. Additionally, the one or more audio capture devices 102 may be positioned within a particular audio environment.

The audio signal processing system 100 also comprises an ASR pre-processing system 104 and an ASR engine 150. The ASR pre-processing system 104 may be configured to perform one or more audio processes with respect to the audio data 106 to provide pre-processed audio for the ASR engine 150. The ASR pre-processing system 104 depicted in FIG. 1 includes a source separation machine learning (ML) engine 110 and/or an audio post-processing engine 112.

The source separation ML engine 110 may utilize an audio source separation model 111 to convert the audio data 106 into processed audio data 107. For example, to facilitate generation of the processed audio data 107, the source separation ML engine 110 may extract an audio feature set from the audio data 106. Additionally, the source separation ML engine 110 may input the audio feature set to the audio source separation model 111 to generate the processed audio data 107. The processed audio data 107 may include one or more audio speech signals configured for ASR. For instance, the one or more audio speech signals may be optimized for ASR by providing source separation with respect to speech undergoing the ASR. In some examples, the processed audio data 107 may be a source separated version of the audio data 106 such that a desirable audio source is separated from undesirable audio. The undesirable audio may be undesirable speech, undesirable reverberations, and/or noise.

In some examples, the audio feature set may represent physical features and/or perceptual features related to the audio data 106. For instance, the audio feature set may include features such as: audio spectrum, short-time Fourier transform (STFT), magnitude, phase, pitch, harmonic, Mel-frequency cepstral coefficients (MFCC), tempo, time signature, discrete cosine transform (DCT), time domain filter banks, wavelet filter banks, cosine distance, and/or one or more other types of features associated with the audio data 106.

The STFT features may represent a Fourier-related transform of a respective audio stream input from the audio data 106 related to frequency, amplitude, and/or time. The magnitude features may represent physical features of a respective audio stream input from the audio data 106 such as magnitude measurements with respect to the audio data 106. The phase features may represent physical features of the audio data 106 such as phase measurements with respect to the audio data 106. The pitch features may represent perceptual features of the audio data 106 such as frequency characteristics related to the audio data 106. The harmonic features may represent perceptual features of the audio data 106 such as frequency characteristics related to harmonics for the audio data 106.

The MFCC features may represent physical features of the audio data 106 such as MFCC measurements with respect to the audio data 106. The MFCC measurements may be extracted based on windowing operations, digital transformations, and/or warping of frequencies on a Mel frequency scale with respect to the audio data 106.

The tempo features may represent perceptual features of the audio data 106 such as beats per minute characteristics related to tempo for the audio data 106. The time signature features may represent perceptual features of the audio data 106 such as beats per musical measure characteristics related to a time signature for the audio data 106. The DCT features may represent a transform of a respective audio stream input from the audio data 106 based on a weighted sum of cosine functions at different frequencies. The time domain filter bank features may represent a respective frequency sub-band of a respective audio stream input from the audio data 106 based on a time-frequency distribution of the respective audio stream input. The wavelet filter bank features may represent a respective frequency sub-band of a respective audio stream input from the audio data 106 based on a respective wavelet filter. The cosine distance features may represent a cosine distance between two or more audio channels associated with the audio data 106.

The audio feature set may be provided as input to the audio source separation model 111. The audio source separation model 111 may be a machine learning model such as a neural network model, a deep neural network model, a convolutional neural network model, a recurrent neural network, or another type of machine learning model. For example, the audio source separation model 111 may be a data entity that describes parameters, hyper-parameters, and/or defined operations configured, trained, and/or the like to generate an audio speech signal that is pre-processed for ASR using one or more machine learning techniques. In some examples, the audio source separation model 111 may include one or more layers, one or more rule-based layers, one or more neural network layers, and/or one or more other types of layers that depend on trained parameters, coefficients, and/or the like. In some embodiments, the audio source separation model 111 may include: a supervised model, an unsupervised model, a semi-supervised model, a reinforcement learning model, and/or the like.

In some examples, the audio source separation model 111 may include multiple models. For instance, the audio source separation model 111 may include a source localizer model and a source generator model. An example audio source separation model 111 is discussed in detail in connection with the audio signal processing systems disclosed in commonly owned U.S. patent application Ser. No. 18/199,212, titled “AUDIO SIGNAL ISOLATION RELATED TO AUDIO SOURCES WITHIN AN AUDIO ENVIRONMENT,” and filed on May 18, 2023, which is hereby incorporated by reference in its entirety. In some examples, the audio source separation model 111 may additionally or alternatively include and/or utilize a deep neural network (DNN) postfilter to further enhance the source separation.

In some examples, the audio source separation model 111 may be configured to predict a location and/or a classification for a respective audio source associated with the audio data 106. For example, the audio source separation model 111 may be trained to predict a location and/or a classification for audio sources in the audio environment relative to a position and/or an orientation of the one or more audio capture devices 102.

In an example, the audio source separation model 111 may provide Vector Symbolic Architecture (VSA) encodings for the location and/or classification for the audio sources. A number of location and/or classification predictions (e.g., a number of VSA encodings) may be based on a number of audio sources located in the audio environment. In some examples, the classification for the audio sources may include an audio class (e.g., a first type of audio source or a second type of audio source), a speech class (e.g., a first type of user class or a second type of user class), an equalization class (e.g., a low frequency class, a middle frequency class, a high frequency class, etc.), and/or another type of classification for the audio sources.

In some examples, the audio source separation model 111 may include a source localizer model. The data provided by the source localizer model may include respective locations and/or classifications for the audio sources. In some examples, the data provided by the source localizer model may include the VSA encodings determined by the source localizer model.

In some examples, the audio source separation model 111 may additionally or alternatively include a source generator model. In some examples, for every prediction of a target audio source class (e.g., speech) and an associated location determined by the source localizer model, a respective source generator model may be executed. The source generator model may be trained to isolate and/or generate a class of sound for specific location coordinates within an audio environment, such that the source generator model outputs sound only from one or more target locations within the audio environment.

In some examples, the source generator model may be trained to generate a class of sound for audio output only from a location, such that the source generator model may learn to actively remove sounds outside of a location, reverberation of the target source, and/or an undesired noise collocated with the target class source at the target location. For example, the source generator model may be trained to select a particular class of sound (e.g., from a set of classes determined by the source localizer model) for output and/or further audio enhancement based on location data provided by the source localizer model.

In some examples, the ASR pre-processing system 104 additionally utilizes the audio post-processing engine 112 to further enhance the audio data 106 and/or the processed audio data 107 for the ASR engine 150. In some examples, the audio post-processing engine 112 may be an audio post-processing module. The audio post-processing engine 112 may perform audio post-processing with respect to the audio data 106 and/or the processed audio data 107 to generate processed audio data 109. The processed audio data 109 includes further audio processing than the audio data 106 and/or the processed audio data 107.

In some examples, the audio post-processing engine 112 performs denoising, dereverberation, speech shaping, artifacts reduction, acoustic echo cancellation (AEC), and/or other audio post-processing with respect to the audio data 106 provided by the one or more audio capture devices 102 and/or the processed audio data 107 provided by the source separation ML engine 110 to generate the processed audio data 109. In some examples, the processed audio data 109 includes one or more filtered audio speech signals corresponding to a filtered version of the one or more audio speech signals generated by the audio source separation model 111.

In some examples, the audio post-processing engine 112 utilizes one or more artifact reduction techniques to provide filtering with respect to the audio data 106 provided by the one or more audio capture devices 102 and/or the processed audio data 107 provided by the source separation ML engine 110 to generate the processed audio data 109. In some examples, the audio post-processing engine 112 utilizes one or more Wiener filters and/or one or more other types of filters to estimate a desirable audio (e.g., speech audio) with respect to the audio data 106 provided by the one or more audio capture devices 102 and/or the processed audio data 107 provided by the source separation ML engine 110. In some examples, the audio post-processing engine 112 utilizes linear prediction to desirable audio with respect to the audio data 106 provided by the one or more audio capture devices 102 and/or the processed audio data 107 provided by the source separation ML engine 110. In some examples, the audio post-processing engine 112 utilizes energy calculations and/or spectrum envelope patterns with respect to the audio data 106 provided by the one or more audio capture devices 102 and/or the processed audio data 107 provided by the source separation ML engine 110 to generate the processed audio data 109.

The ASR engine 150 manages and/or executes one or more automatic speech recognition processes to generate textual data 108 based on the ASR pre-processing (e.g., the front-end audio processing) related to the one or more audio capture devices 102 and/or the ASR pre-processing system 104. In some examples, the ASR engine 150 inputs the processed audio data 107 to an ASR model 113 configured to generate the textual data 108. The textual data 108 includes information in a text format. In some examples, the textual data 108 is associated with speech text for an audio source (e.g., a speaker) associated with the audio data 106. In some examples, the textual data 108 includes a transcript associated with speech-to-text.

In some examples, the ASR model 113 is a machine learning model such as a neural network model, a deep neural network model, a convolutional neural network model, a recurrent neural network, or another type of machine learning model. For example, the ASR model 113 may be a data entity that describes parameters, hyper-parameters, and/or defined operations configured, trained, and/or the like to generate the textual data 108 using one or more machine learning techniques. In some examples, the ASR model 113 may include one or more layers, one or more rule-based layers, one or more neural network layers, and/or one or more other types of layers that depend on trained parameters, coefficients, and/or the like. In some embodiments, the ASR model 113 may include: a supervised model, an unsupervised model, a semi-supervised model, a reinforcement learning model, and/or the like.

In some examples, the ASR model 113 is configured for audio deep learning associated with Mel spectrograms, MFCCs, speaker/content embeddings, a neural vocoder, Residual Vector Quantization (RVQ), Linear Prediction Cepstral Coefficients (LPCC), Perceptual Linear Prediction (PLP) coefficients, and/or other audio processing associated with the processed audio data 107 to generate the textual data 108. To provide the textual data 108, the ASR model 113 may perform sound classification with respect to the processed audio data 107 to generate respective transcript labels for respective portions of the processed audio data 107.

In some examples, the ASR engine 150 additionally or alternatively inputs the processed audio data 109 to the ASR model 113 to generate the textual data 108. In some examples, the ASR model 113 may additionally or alternatively perform sound classification with respect to the processed audio data 109 to generate respective transcript labels for respective portions of the processed audio data 109.

In some examples, the audio feature set is additionally or alternatively input to the ASR model 113 to generate the textual data 108. For example, features data 115 that includes at least the audio feature set associated with the audio source separation model 111 may be provided as input to the ASR model 113 to enhance ASR provided by the ASR engine 150 to generate the textual data 108.

In some examples, the audio data 107 may be provided as input to the audio post-processing engine 112. Based on the audio data 107, the audio post-processing engine 112 may generate a filtered audio speech signal associated with the audio data 106. Additionally, in some examples, the filtered audio speech signal may be provided to the ASR model 113 to generate the textual data 108.

In some examples, the audio signal processing system 100 additionally includes one or more video capture devices 103. The one or more video capture devices 103 may respectively be devices configured to capture video related to the one or more sound sources. The one or more video capture devices 103 may include one or more sensors configured for capturing video by converting light into one or more electrical signals. The video captured by the one or more video capture devices 103 may also be converted into video data 105. In some examples, the video data 105 includes video frames related to a speaker associated with the audio data 106. In an example, the one or more video capture devices 103 are one or more video cameras. In some examples, the one or more video capture devices 103 and the one or more audio capture devices 102 may be integrated together in one or more capture devices.

In some examples, to facilitate generation of the processed audio data 107 and/or the processed audio data 109, the source separation ML engine 110 may additionally extract a video feature set from the video data 105. Additionally, the source separation ML engine 110 may input the video feature set to the audio source separation model 111 to improve source separation for the processed audio data 107. In some examples, the features data 115 provided to the ASR engine 150 may additionally include the video feature set. In some examples, the video feature set may include video features such as: facial features, mouth features, eye features, object recognition features, facial recognition features, person recognition features, and/or other features related to a speaker associated with the audio data 106. In some examples, the source separation ML engine 110 may utilize the video data 105 and/or related video features set to determine directionality of an audio source for desirable audio and/or undesirable audio in the audio environment. In some examples, one or more of beamforming or beamsteering associated with the one or more audio capture devices 102 may additionally or alternatively be optimized based on the video feature set. In some examples, the one or more audio capture devices 102 may include an MVDR beamforming module or another type of beamforming module to provide the beamforming and/or beamsteering. In some examples, the one or more video capture devices 103 may transmit source location estimation information to the one or more audio capture devices 102 to facilitate the beamforming and/or beamsteering. In some examples, one or more MVDR coefficients associated with beamforming and/or beamsteering may be modified (e.g., set to a null value) based on the video feature set such the beamforming and/or beamsteering is steered away from undesirable audio source locations in the audio environment.

In some examples, the source separation ML engine 110 may additionally or alternatively receive undesirable audio data 101 as input. The undesirable audio data 101 may include one or more known undesirable audio signals to be removed from the audio data 106. In some examples, the source separation ML engine 110 may extract an audio feature set from the undesirable audio data 101. The audio feature set associated with the undesirable audio data 101 may be provided as an additional input to the audio source separation model 111. In some examples, the audio feature set associated with the undesirable audio data 101 may include features such as: audio spectrum, STFT, magnitude, phase, pitch, harmonic, MFCC, tempo, time signature, DCT, time domain filter banks, wavelet filter banks, cosine distance, and/or one or more other types of features associated with the undesirable audio data 101. In some examples, the source separation ML engine 110 may utilize the undesirable audio data 101 to provide AEC with respect to the audio data 106.

In some examples, ASR data 117 associated with the ASR engine 150 may be provided as feedback (e.g., via a feedback loop) to the one or more audio capture devices 102 and/or the audio post-processing engine 112 to further optimize the one or more audio capture devices 102 and/or the audio post-processing engine 112 for ASR applications. In some examples, the ASR data 117 may be utilized to adjust one or more parameters associated with the audio post-processing engine 112. For example, the ASR data 117 may be utilized to adjust one or more parameters associated with denoising, dereverberation, speech shaping, artifacts reduction, AEC, and/or other audio processing provided via the audio post-processing engine 112.

In some examples, beamforming and/or beamsteering associated with the one or more audio capture devices 102 may be optimized for ASR using the ASR data 117. In some examples, MVDR coefficients associated with the beamforming and/or beamsteering may be adjusted using the ASR data 117. For instance, the ASR data 117 may be utilized to configure one or more MVDR coefficients with null values to improve audio isolation associated with beamforming prior to source separation via the ASR pre-processing system 104. A null value may correspond to a known undesirable audio source or another type of undesirable location in the audio environment. In some examples, denoising, dereverberation, speech shaping, and/or artifacts reduction parameters associated with the audio post-processing engine 112 may be optimized for ASR using the ASR data 117. The ASR data 117 may be ASR feedback data that includes information such as, but not limited to: transcript text, a confidence score, an estimated word error rate (WER), and/or other ASR information associated with the textual data 108. In some examples, the ASR data 117 may be additionally or alternatively utilized to optimize extraction of the video data 105 via the one or more video capture devices 103.

Accordingly, the ASR pre-processing system 104 may provide improved ASR for the audio data 106 as compared to traditional ASR techniques. Additionally, accuracy of localization of a sound source in an audio environment may be improved by employing the ASR pre-processing system 104. The ASR pre-processing system 104 may additionally or alternatively be adapted to produce improved audio signals with reduced noise, reverberation, and/or other undesirable audio artifacts even in view of exacting audio latency requirements. For example, the ASR pre-processing system 104 may remove or suppress undesirable noise for predefined noise locations in an audio environment and/or for noise locations provided via source localization. In some examples, the ASR pre-processing system 104 may remove or suppress undesirable audio via AEC and/or another type of audio processing. As such, audio may be provided to ASR applications without the undesirable sound reflections.

The ASR pre-processing system 104 may also employ fewer computing resources when compared to traditional audio processing systems that are used for audio processing. Additionally or alternatively, in one or more embodiments, the ASR pre-processing system 104 may be configured to deploy a smaller number of memory resources allocated to beamforming, source separation, denoising, dereverberation, and/or other audio processing for an audio signal sample such as, for example, the audio data 106. In still other embodiments, the ASR pre-processing system 104 may be configured to improve processing speed of beamforming operations, source separation operations, denoising operations, dereverberation operations, and/or audio filtering operations. These improvements may enable an improved audio processing systems to be deployed in microphones or other hardware/software configurations where processing and memory resources are limited, and/or where processing speed and efficiency is important.

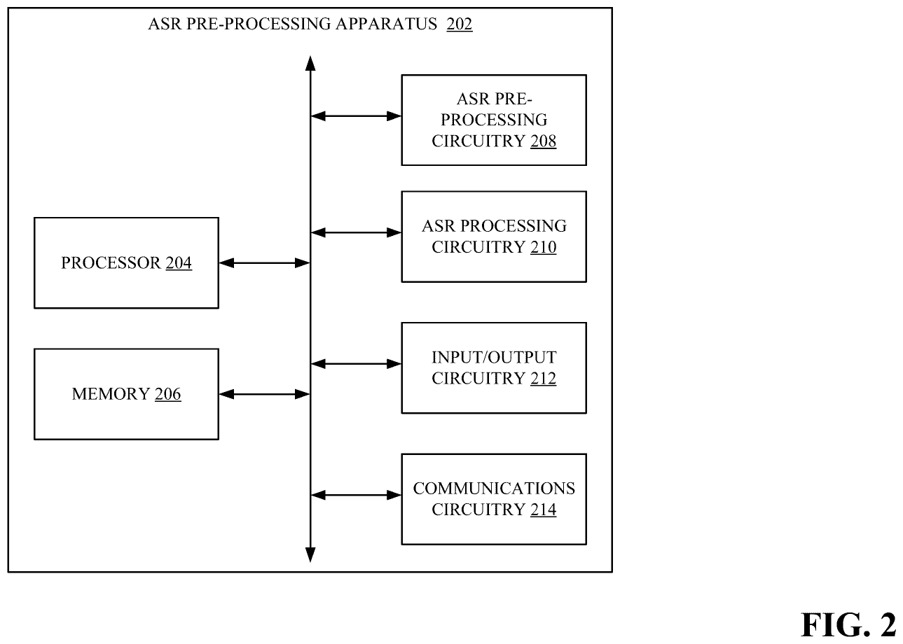

FIG. 2 illustrates an example ASR pre-processing apparatus 202 configured in accordance with one or more embodiments of the present disclosure. The ASR pre-processing apparatus 202 may be configured to perform one or more techniques described in FIG. 1 and/or one or more other techniques described herein.

The ASR pre-processing apparatus 202 may be a computing system communicatively coupled with one or more circuit modules related to audio processing. The ASR pre-processing apparatus 202 may comprise or otherwise be in communication with a processor 204, a memory 206, ASR pre-processing circuitry 208, ASR processing circuitry 210, input/output circuitry 212, and/or communications circuitry 214. In some embodiments, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, video data, audio features, video features, textual data, ASR feedback data, or the like, for enabling the ASR pre-processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the ASR pre-processing apparatus 202 includes the ASR pre-processing circuitry 208. The ASR pre-processing circuitry 208 may be any means embodied in either hardware or a combination of hardware and software that is configured to perform one or more functions disclosed herein related to the ASR pre-processing system 104 (e.g., the source separation ML engine 110 and/or the audio post-processing engine 112). In one or more examples, the ASR pre-processing apparatus 202 includes the ASR processing circuitry 210. The ASR processing circuitry 210 may be any means embodied in either hardware or a combination of hardware and software that is configured to perform one or more functions disclosed herein related to the ASR engine 150 and/or other audio processing of the audio data 106 received from the one or more audio capture devices 102.

In some examples, the ASR pre-processing apparatus 202 includes the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the ASR pre-processing apparatus 202 includes the communications circuitry 214. The communications circuitry 214 may be any means embodied in either hardware or a combination of hardware and software that is configured to receive and/or transmit data from/to a network and/or any other device or module in communication with the ASR pre-processing apparatus 202. In this regard, the communications circuitry 214 may comprise, for example, an antennae or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

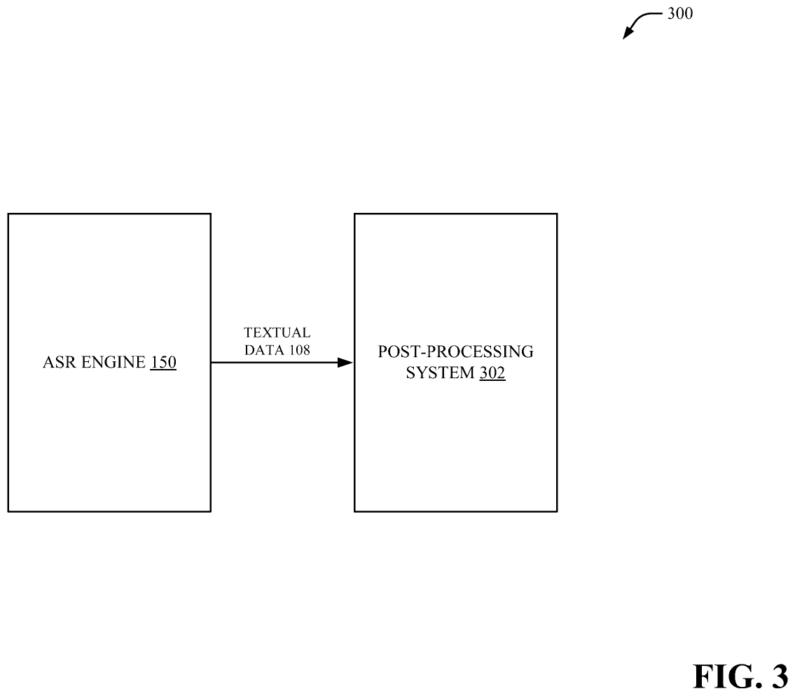

FIG. 3 illustrates a text post-processing system 300 according to one or more embodiments of the present disclosure. The text post-processing system 300 includes the ASR engine 150 and a post-processing system 302. The post-processing system 302 receives the textual data 108 provided by the ASR engine 150. In some examples, the post-processing system 302 is a user experience system that interacts with one or more entities in an audio environment. For example, the user experience system may output media content, audio, video, imagery, text, lighting, user interface data, and/or robotic automation controls to interface with one or more entities in an audio environment. In some examples, the post-processing system 302 is a text post-processing system such as a large language model (LLM) or another type of text post-processing that further enhances the textual data 108 to provide an enhanced version of the textual data 108 (e.g., enhanced textual data) associated with improved transcript accuracy and/or improved contextualization. In some examples, the LLM is a generative machine learning model configured to generate an enhanced version of the textual data 108. In some embodiments, the LLM is configured as or otherwise associated with an autoregressive LLM, a generative pre-trained transformer (GPT) model, or another type of generative machine learning model configured to generate to generate an enhanced version of the textual data 108. In some examples, the LLM may enhance contextual information (e.g., a contextual transcript associated with a question or answer) included in the textual data 108 to provide the enhanced version of the textual data 108 (e.g., enhanced textual data).

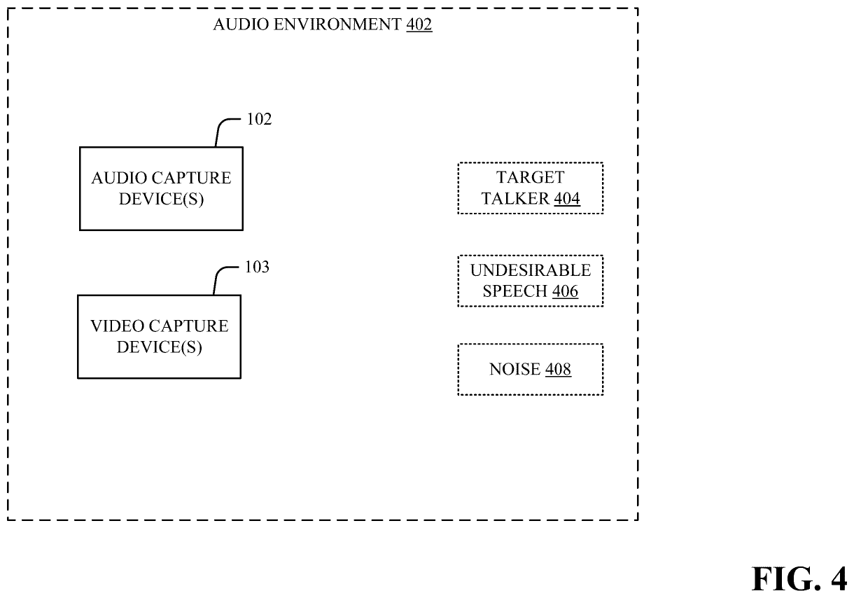

FIG. 4 illustrates an example audio environment 402 according to one or more embodiments of the present disclosure. The audio environment 402 may be an indoor environment, an outdoor environment, an entertainment environment, a user experience environment, a room, a performance hall, a broadcasting environment, a sports stadium or arena, a virtual environment, or another type of audio environment. The audio environment 402 includes the one or more audio capture devices 102 that are respectively capable of capturing audio from one or more audio sources and/or other audio in the audio environment 402. For example, the one or more audio capture devices 102 may capture audio (e.g., the audio data 106) associated with a target talker 404, undesirable speech 406, and/or noise 408 in the audio environment 402. In some examples, the one or more audio capture devices 102 are respectively configured as microphone arrays. In some examples, the audio environment 402 additionally includes the one or more video capture devices 103 to capture video (e.g., the video data 105) associated with the target talker 404. In some examples, the one or more video capture devices 103 recognizes the target talker 404 and/or steers one or more beams for the one or more audio capture devices 102 based on an object recognition technique and/or a defined object held by the target talker 404. In various examples, the ASR pre-processing system 104 performs pre-processing with respect to the audio and/or the video in the audio environment 402 to provide source separation with respect to the target talker 404 for ASR applications or other types of audio applications.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

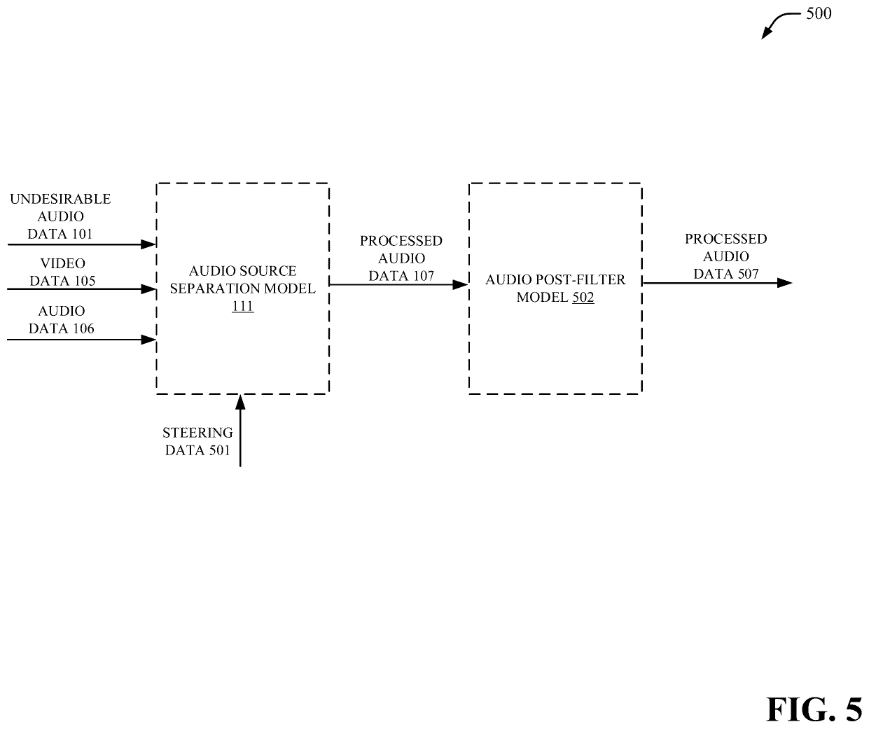

FIG. 5 illustrates a source separation sub-system 500 according to one or more embodiments of the present disclosure. The source separation sub-system 500 may be a sub-system of the audio signal processing system 100. In some examples, the source separation sub-system 500 is related to the source separation ML engine 110. The source separation sub-system 500 includes the audio source separation model 111 and an audio post-filter model 502. As further disclosed herein, the audio source separation model 111 may provide the processed audio data 107 based on the audio data 106, the video data 105, and/or the undesirable audio data 101. In some examples, the audio source separation model 111 may additionally utilize steering data 501 associated with beamforming and/or beamsteering to further enhance the audio source separation. In some examples, the steering data 501 is provided by the one or more audio capture devices 102.

To further optimize the processed audio data 107 provided by the audio source separation model 111, the processed audio data 107 may be provided as input to the audio post-filter model 502. The audio post-filter model 502 may further process the processed audio data 107 to provide processed audio data 507. For example, an audio speech signal of the processed audio data 107 may be provided as input to the audio post-filter model 502. Additionally, based on the audio speech signal, the audio post-filter model 502 may generate a processed audio speech signal that is further processed for ASR. The processed audio data 507 may include optimized source separation and/or cleaner target audio as compared to the processed audio data 107. In some examples, the audio post-filter model 502 may be a DNN model such as a U-Net model or another type of neural network model. In some examples, the audio post-filter model 502 may be tuned for estimating a target audio signal and/or a noise signal to provide improved audio source separation. In some examples, the audio post-filter model 502 may utilize an attention gate in the DNN to suppress noise while augmenting the target audio signal. In some examples, the audio post-filter model 502 may utilize one or more speech synthesis techniques to further enhance the audio source separation. Additionally, in some examples, the processed audio data 507 may be provided as input to an ASR model (e.g., the ASR model 113) to generate textual data (e.g., the textual data 108).

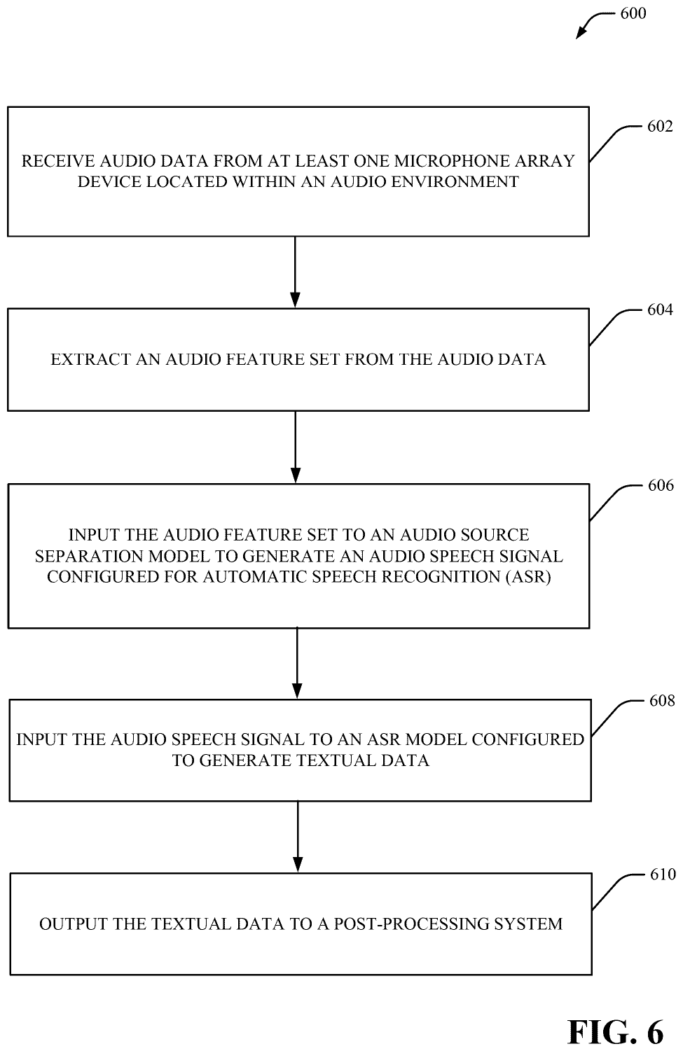

FIG. 6 is a flowchart diagram of an example process 600 for providing front-end audio processing for automatic speech recognition, in accordance with, for example, the ASR pre-processing apparatus 202 illustrated in FIG. 2. Via the various operations of the process 600, the ASR pre-processing apparatus 202 may enhance quality, reliability, and/or source separation of beamformed audio data for one or more ASR applications.

The process 600 begins at operation 602 that receives (e.g., by the ASR pre-processing circuitry 208 and/or the ASR processing circuitry 210) audio data from at least one microphone array device located within an audio environment. The audio environment may be an indoor environment, an outdoor environment, an entertainment environment, a user experience environment, a room, a performance hall, a broadcasting environment, a sports stadium or arena, a virtual environment, or another type of audio environment.

The process 600 also includes an operation 604 that extracts (e.g., by the ASR pre-processing circuitry 208) an audio feature set from the audio data. The audio feature set may represent physical features and/or perceptual features related to the audio data. For instance, the audio feature set may include features such as: audio spectrum, STFT, magnitude, phase, pitch, harmonic, MFCC, tempo, time signature, DCT, time domain filter banks, wavelet filter banks, cosine distance, and/or one or more other types of features associated with the audio data.

The process 600 also includes an operation 606 that inputs (e.g., by the ASR pre-processing circuitry 208) the audio feature set to an audio source separation model to generate an audio speech signal configured for automatic speech recognition (ASR). For example, the audio speech signal may be pre-processed for the ASR via source separation of desired audio sources with respect to the audio data. The audio source separation model may be a machine learning model such as a neural network model, a deep neural network model, a convolutional neural network model, a recurrent neural network, or another type of machine learning model configured to provide audio source separation with respect to the audio data. In some examples, the speech signal is associated with an audio embedding, a neural vocoder format, an RVQ format, and/or another type of audio format.

The process 600 also includes an operation 608 that inputs (e.g., by the ASR processing circuitry 210) the audio speech signal to an ASR model configured to generate textual data. The audio source separation model may be a machine learning model such as a neural network model, a deep neural network model, a convolutional neural network model, a recurrent neural network, or another type of machine learning model configured to provide automatic speech recognition with respect to the audio speech signal. In some examples, the audio feature set is input to the ASR model to generate the textual data associated with the audio speech signal.

The process 600 also includes an operation 610 that outputs (e.g., by the ASR processing circuitry 210) the textual data to a post-processing system. The post-processing system may be a user experience system, a text post-processing system, or another type of post-processing system for the textual data. In some examples, the user experience system is configured to provide digital entertainment output. The digital entertainment output may include audio, video, imagery, haptic output, and/or other output configured to provide digital entertainment. In some examples, the text post-processing system is configured to enhance the textual data. In some examples, the post-processing system includes a large language model configured to generate one or more inferences with respect to the textual data.

In some examples, the audio speech signal associated with the audio source separation model is input to an audio post-processing module configured to generate a filtered audio speech signal associated with the audio data. In some examples, the filtered audio speech signal is input to the ASR model to generate the textual data.

In some examples, beamforming and/or beamsteering associated with the one or more microphone array devices is optimized based at least in part on ASR feedback data associated with the ASR model.

In some examples, one or more MVDR coefficients associated with the one or more microphone array devices are adjusted based at least in part on ASR feedback data associated with the ASR model.

In some examples, the audio speech signal associated with the audio source separation model is input to an audio post-processing module configured to generate a filtered audio speech signal associated with the audio data. Additionally, in some examples, the filtered audio speech signal is input to the ASR model to generate the textual data. In some examples, one or more parameters associated with the audio post-processing module are adjusted based at least in part on ASR feedback data associated with the ASR model.

In some examples, video data captured by the one or more microphone array devices and/or a video capture device located within the audio environment is received. In some examples, a video feature set is extracted from the video data. Additionally, in some examples, the video feature set is input to the audio source separation model to generate the audio speech signal. In some examples, beamforming and/or beamsteering associated with the one or more microphone array devices is optimized based at least in part on the video feature set.

In some examples, the audio feature set is a first audio feature set. Additionally, in some examples, one or more undesirable audio signals related to the audio environment are received. In some examples, a second audio feature set is extracted from the one or more undesirable audio signals. In some examples, the second audio feature set is input to the audio source separation model to generate the audio speech signal.

In some examples, the audio speech signal is input to an audio post-filter model configured to generate a processed audio speech signal that is further processed for the ASR. Additionally, in some examples, the processed audio speech signal is input to the ASR model to generate the textual data.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive audio data captured by one or more microphone array devices located within an audio environment.

Clause 2. The apparatus of Clause 1, wherein the instructions are further operable to cause the apparatus to: extract an audio feature set from the audio data.

Clause 3. The apparatus of any the aforementioned Clauses, wherein the instructions are further operable to cause the apparatus to: input the audio feature set to an audio source separation model to generate an audio speech signal that is pre-processed for automatic speech recognition (ASR).

Clause 4. The apparatus of any the aforementioned Clauses, wherein the instructions are further operable to cause the apparatus to: input the audio speech signal to an ASR model configured to generate textual data.

Clause 5. The apparatus of any the aforementioned Clauses, wherein the instructions are further operable to cause the apparatus to: output the textual data to a post-processing system.

Clause 6. The apparatus of any the aforementioned Clauses, wherein the instructions are further operable to cause the apparatus to: input the audio feature set to the ASR model to generate the textual data associated with the audio speech signal.

Clause 7. The apparatus of any the aforementioned Clauses, wherein the instructions are further operable to cause the apparatus to: input the audio speech signal associated with the audio source separation model to an audio post-processing module configured to generate a filtered audio speech signal associated with the audio data.

Clause 8. The apparatus of any the aforementioned Clauses, wherein the instructions are further operable to cause the apparatus to: input the filtered audio speech signal to the ASR model to generate the textual data.

Clause 9. The apparatus of any the aforementioned Clauses, wherein the instructions are further operable to cause the apparatus to: optimize one or more of beamforming or beamsteering associated with the one or more microphone array devices based at least in part on ASR feedback data associated with the ASR model.

Clause 10. The apparatus of any the aforementioned Clauses, wherein the instructions are further operable to cause the apparatus to: adjust one or more minimum variance distortionless response (MVDR) coefficients associated with the one or more microphone array devices based at least in part on ASR feedback data associated with the ASR model.

Clause 11. The apparatus of any the aforementioned Clauses, wherein the instructions are further operable to cause the apparatus to: input the audio speech signal associated with the audio source separation model to an audio post-processing module configured to generate a filtered audio speech signal associated with the audio data.

Clause 12. The apparatus of any the aforementioned Clauses, wherein the instructions are further operable to cause the apparatus to: input the filtered audio speech signal to the ASR model to generate the textual data.

Clause 13. The apparatus of any the aforementioned Clauses, wherein the instructions are further operable to cause the apparatus to: adjust one or more parameters associated with the audio post-processing module based at least in part on ASR feedback data associated with the ASR model.

Clause 14. The apparatus of any the aforementioned Clauses, wherein the instructions are further operable to cause the apparatus to: receive video data captured by the one or more microphone array devices or a video capture device located within the audio environment.

Clause 15. The apparatus of any the aforementioned Clauses, wherein the instructions are further operable to cause the apparatus to: extract a video feature set from the video data.

Clause 16. The apparatus of any the aforementioned Clauses, wherein the instructions are further operable to cause the apparatus to: input the video feature set to the audio source separation model to generate the audio speech signal.

Clause 17. The apparatus of any the aforementioned Clauses, wherein the instructions are further operable to cause the apparatus to: optimize one or more of beamforming or beamsteering associated with the one or more microphone array devices based at least in part on the video feature set.

Clause 18. The apparatus of any the aforementioned Clauses, wherein the audio feature set is a first audio feature set, and wherein the instructions are further operable to cause the apparatus to: receive one or more undesirable audio signals related to the audio environment.

Clause 19. The apparatus of any the aforementioned Clauses, wherein the instructions are further operable to cause the apparatus to: extract a second audio feature set from the one or more undesirable audio signals.

Clause 20. The apparatus of any the aforementioned Clauses, wherein the instructions are further operable to cause the apparatus to: input the second audio feature set to the audio source separation model to generate the audio speech signal.

Clause 21. The apparatus of any the aforementioned Clauses, wherein the audio speech signal is associated with an audio embedding, a neural vocoder format, or a Residual Vector Quantization (RVQ) format.

Clause 22. The apparatus of any the aforementioned Clauses, wherein the audio source separation model comprises a neural network model.

Clause 23. The apparatus of any the aforementioned Clauses, wherein the audio source separation model is configured to perform source localization and source generation for an audio source associated with the audio data.

Clause 24. The apparatus of any the aforementioned Clauses, wherein the post-processing system comprises a text post-processing system configured to enhance the textual data.

Clause 25. The apparatus of any the aforementioned Clauses, wherein the post-processing system comprises a large language model configured to generate one or more inferences with respect to the textual data.

Clause 26. The apparatus of any the aforementioned Clauses, wherein the post-processing system comprises a user experience system configured to provide digital entertainment output.

Clause 27. The apparatus of any the aforementioned Clauses, wherein the instructions are further operable to cause the apparatus to: input the audio speech signal to an audio post-filter model configured to generate a processed audio speech signal that is further processed for the ASR.

Clause 28. The apparatus of any the aforementioned Clauses, wherein the instructions are further operable to cause the apparatus to: input the processed audio speech signal to the ASR model to generate the textual data.

Clause 28. The apparatus of any the aforementioned Clauses, wherein the audio post-filter model is a deep neural network model.

Clause 29. A computer-implemented method comprising steps related to any of the aforementioned Clauses.

Clause 30. A computer program product, stored on a computer readable medium, comprising instructions that, when executed by one or more processors of the apparatus, cause the one or more processors to perform one or more operations related to any of the aforementioned Clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein. they are used in a generic and descriptive sense only and not for purposes of limitation, unless described otherwise.

That which is claimed is:

1. An apparatus comprising at least one processor and a memory storing instructions that are operable, when executed by the processor, to cause the apparatus to:
receive audio data captured by one or more microphone array devices located within an audio environment;
extract an audio feature set from the audio data;
input the audio feature set to an audio source separation model to generate an audio speech signal that is pre-processed for automatic speech recognition (ASR);
input the audio speech signal to an ASR model configured to generate textual data; and
output the textual data to a post-processing system.

2. The apparatus of claim 1, wherein the instructions are further operable to cause the apparatus to:
input the audio feature set to the ASR model to generate the textual data associated with the audio speech signal.

3. The apparatus of claim 1, wherein the instructions are further operable to cause the apparatus to:
input the audio speech signal associated with the audio source separation model to an audio post-processing module configured to generate a filtered audio speech signal associated with the audio data.

4. The apparatus of claim 3, wherein the instructions are further operable to cause the apparatus to:
input the filtered audio speech signal to the ASR model to generate the textual data.

5. The apparatus of claim 1, wherein the post-processing system comprises a text post-processing system configured to enhance the textual data.

6. The apparatus of claim 1, wherein the post-processing system comprises a large language model configured to generate one or more inferences with respect to the textual data.

7. The apparatus of claim 1, wherein the post-processing system comprises a user experience system configured to provide digital entertainment output.

8. The apparatus of claim 1, wherein the instructions are further operable to cause the apparatus to:
optimize one or more of beamforming or beamsteering associated with the one or more microphone array devices based at least in part on ASR feedback data associated with the ASR model.

9. The apparatus of claim 1, wherein the instructions are further operable to cause the apparatus to:
adjust one or more minimum variance distortionless response (MVDR) coefficients associated with the one or more microphone array devices based at least in part on ASR feedback data associated with the ASR model.

10. The apparatus of claim 1, wherein the instructions are further operable to cause the apparatus to:
input the audio speech signal associated with the audio source separation model to an audio post-processing module configured to generate a filtered audio speech signal associated with the audio data;
input the filtered audio speech signal to the ASR model to generate the textual data; and
adjust one or more parameters associated with the audio post-processing module based at least in part on ASR feedback data associated with the ASR model.

11. The apparatus of claim 1, wherein the instructions are further operable to cause the apparatus to:
receive video data captured by the one or more microphone array devices or a video capture device located within the audio environment;
extract a video feature set from the video data; and
input the video feature set to the audio source separation model to generate the audio speech signal.

12. The apparatus of claim 11, wherein the instructions are further operable to cause the apparatus to:
optimize one or more of beamforming or beamsteering associated with the one or more microphone array devices based at least in part on the video feature set.

13. The apparatus of claim 1, wherein the audio feature set is a first audio feature set, and wherein the instructions are further operable to cause the apparatus to:
receive one or more undesirable audio signals related to the audio environment;
extract a second audio feature set from the one or more undesirable audio signals; and
input the second audio feature set to the audio source separation model to generate the audio speech signal.

14. The apparatus of claim 1, wherein the audio speech signal is associated with an audio embedding, a neural vocoder format, or a Residual Vector Quantization (RVQ) format.

15. The apparatus of claim 11, wherein the instructions are further operable to cause the apparatus to:
input the audio speech signal to an audio post-filter model configured to generate a processed audio speech signal that is further processed for the ASR; and
input the processed audio speech signal to the ASR model to generate the textual data.

16. A computer-implemented method comprising:
receiving audio data captured by one or more microphone array devices located within an audio environment;
extracting an audio feature set from the audio data;
inputting the audio feature set to an audio source separation model to generate an audio speech signal that is pre-processed for automatic speech recognition (ASR);
inputting the audio speech signal to an ASR model configured to generate textual data; and
outputting the textual data to a post-processing system.

17. The computer-implemented method of claim 16, further comprising:
inputting the audio feature set to the ASR model to generate the textual data associated with the audio speech signal.

18. The computer-implemented method of claim 16, further comprising:
inputting the audio speech signal associated with the audio source separation model to an audio post-processing module configured to generate a filtered audio speech signal associated with the audio data.

19. The computer-implemented method of claim 18, further comprising:
inputting the filtered audio speech signal to the ASR model to generate the textual data.

20. A computer program product, stored on a computer readable medium, comprising instructions that, when executed by one or more processors of an apparatus, cause the one or more processors to:
receive audio data captured by one or more microphone array devices located within an audio environment;
extract an audio feature set from the audio data;
input the audio feature set to an audio source separation model to generate an audio speech signal that is pre-processed for automatic speech recognition (ASR);
input the audio speech signal to an ASR model configured to generate textual data; and
output the textual data to a post-processing system.
